(19) United States
(12) Patent Application Publication
(10) Pub. No.: US 2012/0181265 A1
(43) Pub. Date: Jul. 19, 2012

(54) FIRING FURNACE CONFIGURATION FOR THERMAL PROCESSING SYSTEM

(75) Inventor: Jean Pierre Menard, Lakeville, MN (US)

(73) Assignee: DESPATCH INDUSTRIES LIMITED PARTNERSHIP, Lakeville, MN (US)

(21) Appl. No.: 13/183,957

(22) Filed: Jul. 15, 2011

Related U.S. Application Data
(60) Provisional application No. 61/364,656, filed on Jul. 15, 2010.

(51) Int. Cl. F27D 11/00

(52) U.S. Cl. 219/388

(57) ABSTRACT

A thermal processing system for processing work pieces such as silicon wafers for photovoltaic cells. The system include a firing furnace comprised of upper and lower banks for microzones having infrared lamps in each microzone. The microzone are lined with or formed of a reflective insulative material. Some embodiments of the system of the invention can be used as or in a continuous infrared furnace of oven having a drying, burn-off and firing zone.

### CROSS-REFERENCE TO RELATED APPLICATION

This application claims the benefit of U.S. Provisional Application No. 61/364,656, filed Jul. 15, 2010, the content of which is hereby incorporated by reference in its entirety.

### FIELD OF THE INVENTION

The invention relates to thermal processing systems for processing of work pieces such as silicon wafers for photovoltaic cells

### BACKGROUND

Continuous infrared furnaces and ovens are widely used in a variety of industries. Work pieces treated in such furnaces include painted or coated substrates that require specific thermal process conditions. Examples of such work pieces include silicon wafers for photovoltaic cells. Front and back side metal contacts of photovoltaic cells, wherein the front side contact typically extends in a grid pattern and the back side contact extends continuously, are initially formed by an electrically conductive metallized paste or ink, for example, applied by a screen printing, inkjet spray or aerosol spray process to silicon wafers. Other architectures achieve the same result. Drying and firing of the applied paste is typically carried out in a thermal processing system that includes an infrared drying furnace and an infrared firing furnace; such systems may further include a cooling chamber. When such thermal processing systems are integrated into a larger production line in a high capacity manufacturing environment that includes additional equipment, for example, for the manufacture of photovoltaic cells, it is desirable that the thermal processing system, while providing adequate and necessary thermal processing, not negatively impact the rate of production line through-put.

### SUMMARY

Some embodiments of the present invention are directed toward configurations of a firing furnace of a thermal processing system, wherein the firing furnace is located downstream of a drying furnace of the system and upstream of an optional cooling chamber of the system. The firing furnace preferably employs a plurality of pairs of infrared lamps, each lamp of each pair being located opposite the other on either side of a conveyor that transports substrates between the lamps. Aspects of some embodiments of the present invention include one or more of: 1.) Tuned infrared lamp wavelength, preferably between one and two microns, for maximum absorption of lamp energy into wafers for photovoltaic cells, and minimum absorption into the surrounding structure of the furnace; 2.) Reflective insulation material lining or forming the interior of the furnace or lining or forming the microzone and dividing walls, the material being formed from relatively high purity (99%) silica, being non-metallic, and having greater than 85% reflectivity to reflect the lamp energy at the tuned wavelength so that reflected energy can contribute to the energy absorbed by the wafers; 3.) Conveyor designed to minimize conductive contact with the substrates conveyed thereon; and 4.) Arrangement of the infrared lamps of the firing furnace into a plurality of zones, wherein a first group of the zones, through which the wafers sequentially travel, are configured to burn off a polymer binder from the metallic paste of each wafer, and a second group of the zones, downstream of the first group, are configured, differently from the first group, to fire, or diffuse and solidify the remaining metal, following the binder ‘burn-off’, in order to form the contacts of each photovoltaic cell.

The aforementioned plurality of zones of the firing furnace are separated from one another by dividing walls that do not interfere with conveyor transport of substrates. One or more infrared lamps in each zone of the second group of zones, which will be designated herein as ‘microzones’, are arranged differently than the one or more lamps included in each of the zones of the first group and are of a different wattage, although the same type of infrared lamp can be employed in all of the zones. For example, a spacing between the conveyor and the one or more lamps in each microzone is smaller than that between the conveyor and each lamp of the first group of zones; and each of the lamps included in each zone, on the same side of the conveyor, are spaced closer to one another in the microzones than in the zones of the first group, resulting in smaller widths of the microzones, along the direction of conveyor travel.

Each microzone or sets of microzone are adapted or can be configured to be independently controlled, such that a temperature in adjacent microzones or sets of microzones may differ by a few degrees Celsius or by as much as approximately 600° C., with a more typical operating temperature differential being about 250° C. According to those embodiments in which each microzone includes a plurality of lamps, the lamps of each microzone are preferably wired in series, and a thermocouple mounted in proximity to at least one of the plurality of lamps in each microzone may provide input for determining the relative temperature of the corresponding microzone.

### BRIEF DESCRIPTION OF THE DRAWINGS

FIG. 1 is a perspective view of an exemplary thermal processing system 100 alongside a cross-section view of a portion of a firing furnace chamber of the system, according to some embodiments of the invention.

FIG. 2 is a schematic elevation view of a furnace chamber according to an embodiment of the invention alongside an enlarged detailed view of a portion of the furnace chamber.

FIG. 3 shows examples of four potential thermal profiles A, B, C, D for a given conveyor speed plotted on a graph of temperature vs. time.

FIG. 4 shows a portion of a conveyor in proximity to entry point of an embodiment of a system of the invention, along with an enlarged detailed view of one segment of the conveyor supporting a work piece, e.g., a wafer/cell.

FIG. 5 is a partial, cross-sectional view of an upper microzone bank according to an embodiment of the invention, and further depicting direct irradiation from lamps and indirect irradiation from reflections of the lamps.

FIG. 6 is a partial cross-sectional view of an upper microzone bank according an embodiment of the invention depicting a transmissive shield positioned below and spaced away from the dividing walls.

### DETAILED DESCRIPTION

The following description is presented to enable a person of ordinary skill in the art to make embodiments of the disclosure. Various modifications to the illustrated embodiments will be readily apparent to those skilled in the art. The present disclosure is not intended to limit the described embodiments, but is to be accorded the widest scope consistent with the principles and features disclosed herein. The following detailed description is to be read with reference to the accompanying Figures, in which like elements in different figures have like reference numerals. The Figures, which are not necessarily to scale, depict selected embodiments and are not intended to limit the scope of the disclosure.

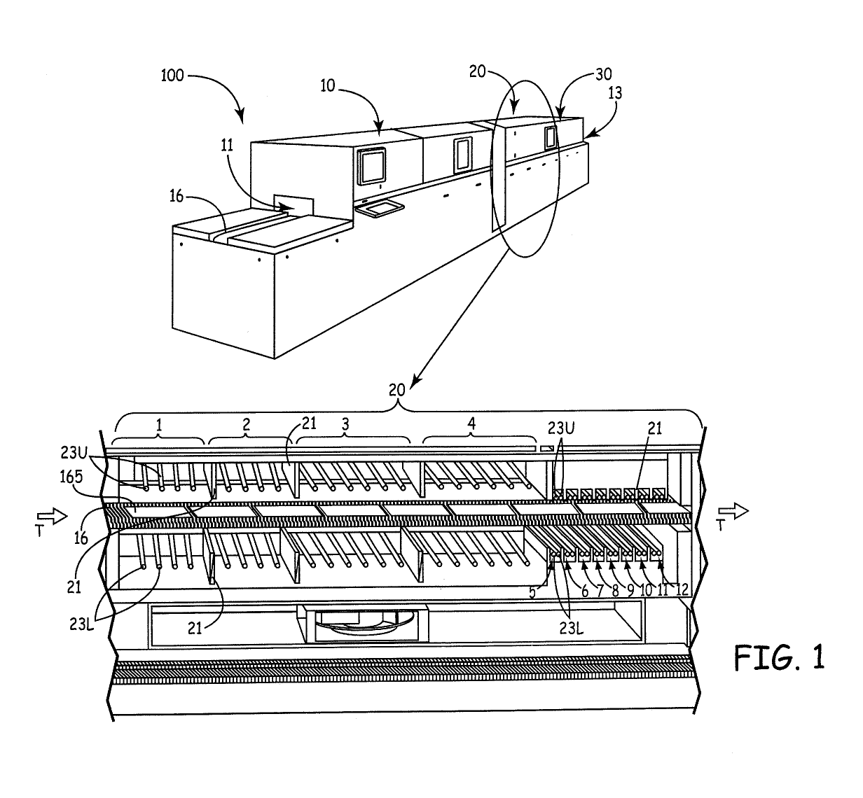

FIG. 1 is a perspective view of an exemplary thermal processing system 100 alongside a cross-section view of a portion of a firing furnace chamber 20 of the system, according to some embodiments. FIG. 1 illustrates firing furnace chamber 20 located downstream of an entry point 11 and a drying furnace 10 of system 100, and upstream of an optional cooling chamber 30 and an exit point 13 of system 100. System 100 is preferably employed in a photovoltaic cell manufacturing line, and a conveyor 16 can be seen extending upstream of entry 11 over a length that is sufficient for loading wafers/cells thereon. However, the system 100 and fire furnace 20 according to some embodiments of the invention may be employed in the manufacture of other work pieces, besides wafers/cells, that require thermal processing. Wafers/cells 165 are transported by conveyor 16 first into drying furnace 10, where volatile organic compounds (VOC's) of the metallized paste are burned off, and then into firing furnace chamber 20, where polymer binder material is burned off in a burn-off zone and then conductive contacts are formed by diffusion and solidification of the remaining metal in a firing zone including a plurality of microzones. Following firing, wafers/cells 165 may exit system 100 at 13 or may be conveyed into an optional cooling chamber 30 prior to exiting system 100 at 13. In alternative embodiments, wafer/cells 165 may exit system 100 at 13 and then are conveyed to a cooling chamber 30 that is not integrated into system 100. Cooling systems known to those skilled in the art to be suitable for this purpose may be used for cooling chamber 30. Despatch's standard radiant/convection cooling system or Despatch's IL-RTS cooling system are two non-limiting examples of preferred cooling systems.

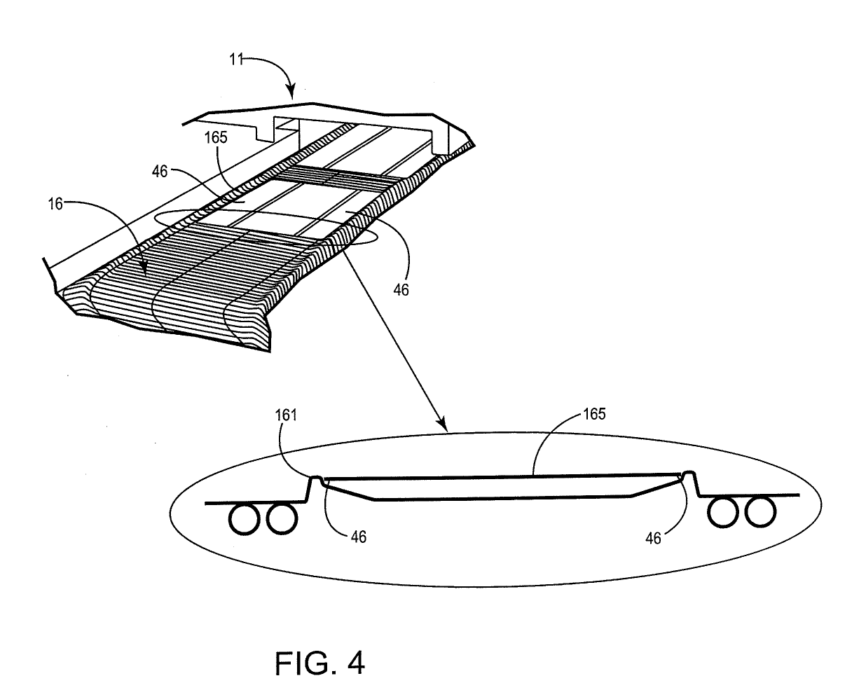

FIG. 1 further illustrates firing furnace chamber 20 configured according to some embodiments of the present invention, wherein dividing walls 21 define twelve zones 1-12 of firing furnace chamber 20, and each zone 1-12 includes a plurality of pairs of infrared (IR) lamps 23 to include other IR heat sources (referred to as lamps for purposes of this application), such that each pair includes an upper IR lamp 23U and a lower IR lamp 23L approximately directly opposite one another on either side of conveyor 16. In some embodiments of the invention, the firing chamber 20 may be provided with more than or less than the 12 zones illustrated in FIG. 1. The conveyor 16 moves through the thermal processing system and its different zones along a path of travel in the direction designated by arrows T. Both sides of each wafer 165 are fired in furnace chamber 20, and wafers 165 are loaded onto conveyor 16 such that a front, or ‘sunny’ side (having the open grid pattern of metallized paste) preferably faces upward, although the ‘sunny’ side may alternatively face downward. Conveyor 16 is configured to thermally decouple the work product from the conveyor so as to eliminate marking of the wafers/cells 165 and to maximize thermal energy transfer and efficiency, as will be described in greater detail below, in conjunction with FIG. 4. According to the illustrated embodiment, when a batch of wafers/cells 165 are conveyed through furnace chamber 20, polymer binder material of the metallic paste is first burned off in zones 1-4 (also referred to as “burn-off zones” or “the burn-off zone”) and then the conductive contacts are formed from the remaining metal in zones 5-12 (also referred to herein as “microzones” or “the firing zone” or “firing zones).

According to FIG. 1, each IR lamp 23 has an elongate cylindrical shape; a length of each lamp 23, defined in a direction perpendicular to the direction of conveyor travel, is sufficient to span a width of chamber 20, which is defined in the same direction. Each lamp 23 may be mounted to an inside surface of furnace chamber 20, either in a cantilever fashion or being supported at either end thereof. Preferably, when processing solar cells, lamps having an average irradiance equal to or less than (≦) 100 W/in² at 200 volts, such as T3 quartz lamps, are utilized as IR lamps 23. However other types of IR lamps may be utilized depending upon the application and specific heat or energy requirements for the type of work pieces being processed. Additional, non-limiting examples of IR emitting lamps or heat sources include silicon carbide heat sources and tungsten halogen lamps. Tungsten halogen lamps may be particularly useful for processing of thin film work pieces and silicon carbide heat sources may be particularly useful in processing of glass-based work pieces. According to preferred embodiments, the wattage of each IR lamp 23 is established in order to produce infrared radiation within the 1.0 to 2.5 micron wavelength range, and preferably within the 1.0 to 2.0 micron wavelength range which maximizes energy absorption into wafers/cells 165, for example, to form the contacts thereof, while minimizing energy absorption into conveyor 16.

Furthermore, according to preferred embodiments, thermal insulation that lines or forms the interior of furnace chamber 20 and/or the microzone, including dividing walls 21, is a highly reflective insulating lining or material. A highly reflective insulation or insulative material is one that is designed to reflect greater than 85% of the radiation energy from IR lamps 23, in the 1 to 2.5 micron wavelength range that was specified above, so that reflected energy can contribute to the energy absorbed by wafers/cells 165. The reflective insulating lining material preferably is non-metallic so as to minimize process contamination of the lining material. One example of a particularly useful reflective insulating material is formed from relatively high purity silica, for example, approximately 99% pure. Such an insulation material is commercially available from St. Gobain under the brand name Quartzel® products.

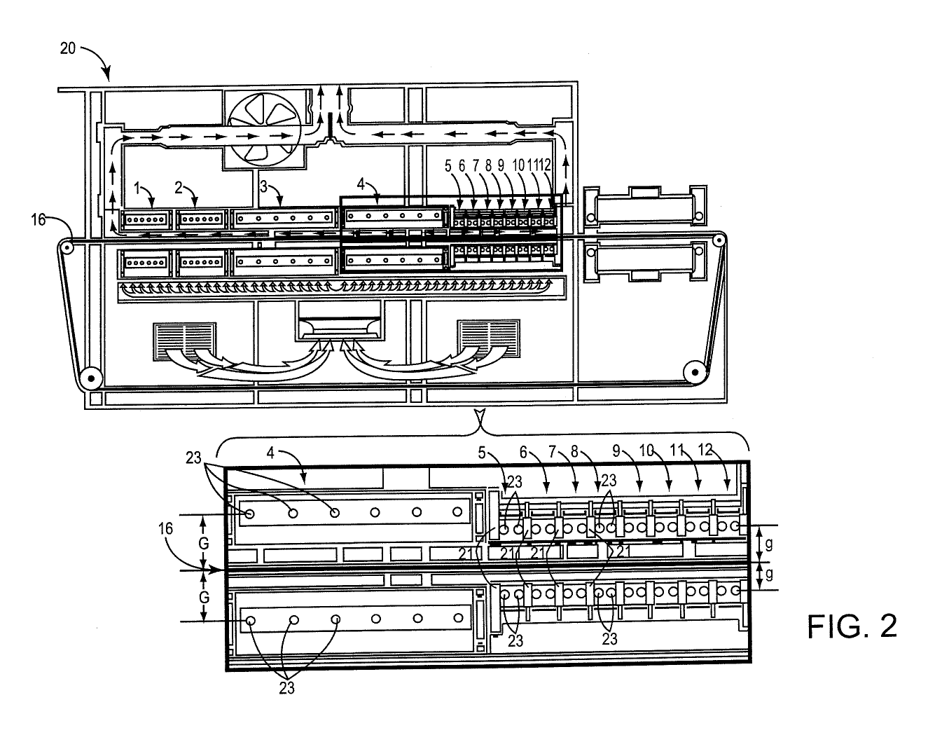

FIG. 2 is a schematic elevation view of furnace chamber 20 alongside an enlarged detailed view of a portion of furnace chamber 20. The unnumbered arrows of FIG. 2 depict the flow of air through furnace chamber 20, according to some embodiments. With reference to the enlarged detailed view of FIG. 2, the arrangement of IR lamps 23 in zones 5-12 is such that each of zones 5-12 has a significantly smaller width, along the direction of conveyor 16 travel and between corresponding dividing walls 21, than that of zone 4 (as well as of zones 1-3); and each upper and lower IR lamp 23U, 23L, of each pair in zones 5-12, are located closer to one another such that a gap g between lamps 23 and conveyor 16, above and below, in zones 5-12, is significantly less than a gap G between lamps 23 and conveyor 16 in zones 1-4. In prior art thermal processing systems, the gap would typically be the same throughout the burn-off and firing zones. The gap in prior art systems are typically between two to four inches which is the same for the gap G. Gap g in the firing zone of systems according to embodiments of the invention is less than 2 inches; for example, gap g may be less than 1.9, less than 1.5, less than 1.3, less than 1.1 inches. Depending upon system design, gap g can be as a narrow as 0.5 inches and may be as narrow as system design allows without inhibiting conveyor speed or causing contact between the work pieces and the dividing walls 21 or lamps 23 or, if provided, transmissive shields abutting or spaced away from the ends of dividing wall 21 and covering the microzones. As a result of the closer proximity of the microzone lamps to the substrates or work pieces, more efficient heating transfer to the substrates is provided.

According to embodiments of the present disclosure, the reduced width of microzones 5-12, and the resulting increased density thereof, provides higher resolution in controlling a thermal profile for substrates that are conveyed therethrough, for example, wafers/cells 165; and the tighter gap g between lamps 23 and the conveyed substrates reduces an angle of incidence of infrared radiation from lamps 23. According to preferred embodiments, each microzone 5-12 has approximately the same width. The width of the microzones is a factor of the desired or target residence time for wafers or other work pieces in the microzone.

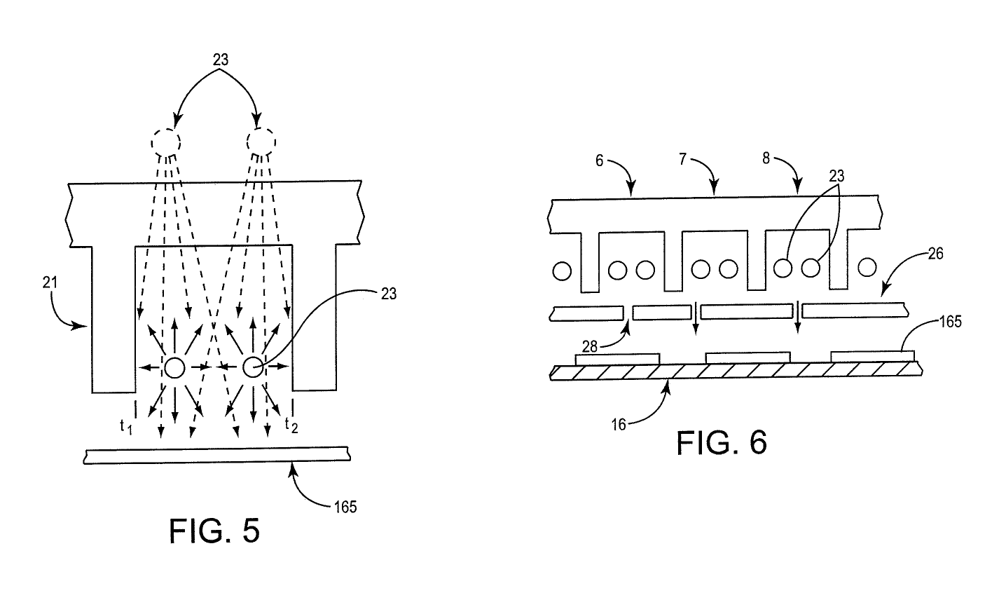

FIG. 5 is a partial, cross-sectional view of a portion of an upper microzone bank according to an embodiment of the invention, and further depicts direct irradiation from lamps 23 and indirect irradiation from reflections of lamps 23. The portion of the upper microzone bank is illustrated with two IR lamps 23 disposed within the microzone. As depicted, the microzone has a generally rectilinear geometry or configuration; however, it should be understood that microzones may be provided with various useful geometries. A time reference “t₁” is positioned at the start of the microzone and a time reference “t₂” is provided at the end of the microzone. The difference between the two time references (t₂−t₁ or Δt) preferably is less than or equal to 0.03 minutes (min.) and more preferably less than or equal to about 0.02 min. For example, if the conveyor speed of travel is approximately 200 inches/minute and the target Δt set point is 0.03 min., the width of the microzone would be about 6 inches; and with the same conveyor speed and Δt of 0.02 min., the width of the microzone would be about 4 inches. So depending upon the processing desired or target conveyor speed and a target residence time, the necessary microzone width can be determined. Thus in some embodiments of the invention, the useful At can range between about 0.01 minutes to about 0.03 minutes.

In FIG. 5, the microzone is also shown with a pair of lamps (in broken line) external to the microzone. This is intended to illustrate an indirect source of IR energy, the reflection of the lamp off of the highly reflective insulating lining. The broken lines extending downward from the reflected lamps illustrates reflected radiation reflected back towards wafer 165 as indirectly irradiating the substrate. Direct radiation is illustrated by the arrows extending from lamps 23 toward wafer 165. The close proximity of the lamps to the substrate provides for concentrated or high direct heat transfer to the substrate or work piece and the reflective radiation provides for uniform heat transfer throughout the substrate.

In thermal processing systems according to the invention, the combination of the increased density of microzones 5-12 and reduced angle of incidence allow for the creation of “crisply” defined thermal profiles wherein a temperature change or difference (ΔT) from one microzone to the next, adjacent microzone may be as large as approximately 600° C., with a more typical operating temperature differential being about 250° C. In the firing of wafers/cells 165, the electrically conductive metallized paste, which contains a silver compound and glass frit, needs to penetrate, or ‘fire through’ an anti-reflective coating in order to make contact with the underlying emitter (e.g., phosphorous/silicon n-type layer that overlays the p-type silicon). If wafers/cells 165 dwell too long at the eutectic temperature (melting point) of the silver compound, the glass frit and silver may also fire through the emitter to the p-type silicon bulk, and thereby create an electrical shunt. Therefore, the ability to tailor the thermal profile for conveyed wafers/cells 165, facilitated by the aforementioned combination of the increased density of microzones 5-12 and the reduced angle of incidence, is an advantage of embodiments disclosed herein, particularly in light of increasingly tighter tolerances on temperatures and time windows of exposure that are required for newly developed metallized pastes.

Thermal processing systems according to embodiments of the invention may be equipped with electronic controls or controllers or control subsystems and programmed to dynamically control temperature or firing profiles in the microzones. The controls preferably are configured for electronic communication with lamps and temperature sensors or thermocouples in the microzones. The controls regulate the power to the lamp to assure that target or preset temperature profiles are repeatable from one process run to another. In some embodiments of the invention, thermal processing system 100 is provided with at least one process parameter sensor disposed in at least one of each pair of opposed microzones, and the electronic controller is in electronic communication with the lamps and at least one process parameter sensor and configured to dynamically control temperatures and firing profiles in the firing zone or microzones.

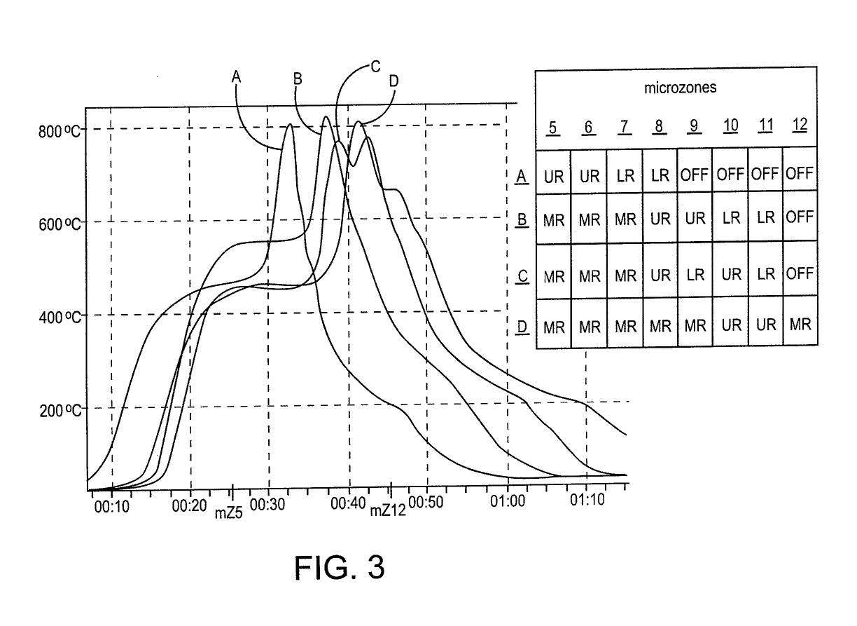

The controller allows for independent control of each microzone 5-12 or sets of microzones together with the aforementioned decreased size and increased density of the microzones, can effectively change the shape of the firing profile without changing the length (time or residence time) of the associated up stream burn-off zone, and can effectively accommodate an approximately constant speed of conveyor 16 in system 100, which constant speed has been established to be consistent with processing speeds of other pieces of equipment in a manufacturing line, e.g., a solar cell manufacturing line, since, from variations of wafers/cells 165 or other work pieces, thermal profiles can be changed by changing settings for the output of each of microzones 5-12 or sets of microzones, rather than by changing a speed of conveyor 16. For example, FIG. 3 shows examples of four potential thermal profiles A, B, C, D for a given conveyor speed, which are plotted on a graph of temperature vs. time.

Profiles A, B, C, D may be established according to temperature settings for each microzone 5-12. The temperature settings may be input into a controller by an operator or an operate may select from preprogrammed temperature setting corresponding to desired temperature profiles. A chart, alongside the graph of FIG. 3, presents exemplary relative settings for each microzone 5-12 for each profile A-D. In some applications, for example, illustrated by profiles A-C, the group of lamps 23 of one or more of microzones 5-12 may be turned off to achieve a particular thermal profile. In the chart, the designation UR represents an upper range of selectable temperature settings, LR designates a lower range of the selectable temperature settings, and MR designates a middle range.

FIG. 4 shows a portion of conveyor 16, in proximity to entry point 11 of system 100 (FIG. 1), along with an enlarged detailed view of one segment 161 of conveyor 16 supporting wafer/cell 165. According to FIG. 4, conveyor 16 is formed by a plurality of segments 161 spaced apart from one another along the direction of travel of conveyor, 16 and each segment 161 has a profile to or is configured to support wafers/cells 165 by only contacting two opposing edges (or edge portions) 46 of each wafer 165. Edges 46 of each wafer 165 may contact each corresponding segment 161 over a distance of less than between approximately 1 to 1.5 mm, for example, so that no contact is made with ‘active’ photovoltaic cell areas of wafers 165 as wafers 165 are conveyed through system 100. Such limited contact reduces thermal conduction between conveyor 16 and wafers 165 and also reduces risk of contamination and/or marking of the active photovoltaic cell areas of the wafers 165.

In some embodiments of system 100 according to the invention, a transmissive shield is provided. The transmissive shield is perforated, provided with openings such as holes or slits. When provided, a shield is disposed between the upper microzone bank and the conveyor and/or between the lower microzone bank and the conveyor. The shield, which may be provided as a plurality of shield sections, may be mounted flush against the ends of the dividing walls or spaced away from the dividing walls. In FIG. 6, a shield 26 is shown positioned below the upper microzone bank and spaced away from dividing walls 21 and above conveyor 16 and wafers 165. The shield 26 or shield sections 26 are perforated to allow for air or gas exchange from the microzones into the product area. The unnumbered arrows of FIG. 6 depict the flow of air or gas from the microzones through openings 28 and into the product area. Air or gas introduced into the microzones are preferably under positive pressure so the flow of gas is directed from the microzones through the openings and into the product area or path of travel. This serves in part to prevent or minimize premature lamp failure due to contamination from loose materials or particulates formed during processing that may fall from the conveyor or work pieces or become airborne and that could accumulate on surfaces of the lamps. The shield can be formed of any suitable material that transmits infrared radiation and that can withstand processing temperatures and conditions. A non-limiting example of one such materials is quartz.

The invention herein above has been described with reference to various and specific embodiments and techniques. It will be understood by one of ordinary skill in the art, however, that reasonable variations and modifications may be made with respect to such embodiments and techniques without substantial departure from either the spirit or scope of the invention defined by the following claims.

What is claimed:

1. A thermal processing system having a path of travel, comprising:
a firing furnace comprised of an upper microzone bank and a lower microzone bank disposed in opposed position along the path of travel, each bank being comprised of a plurality of microzones separated by dividing walls and one or more infrared lamps in each microzone, the microzones and dividing walls being lined with or formed of a reflective insulative material.

2. The thermal processing system of claim 1, wherein the reflective insulative material is a non-metallic material have greater than 85% reflectivity.

3. The thermal processing system of claim 1, further comprising a burn-off area upstream from the microzone banks.

4. The thermal processing system of claim 3, wherein the burn-off area is comprised of a plurality of paired burn-off zones disposed in opposed position along the path of travel, the burn-off zones are separated by dividing walls and have one or more infrared lamps in each burn-off zone, and the burn-off zones and the dividing walls are lined with or formed of a reflective insulative material.

5. The thermal processing system of claim 1, further comprising a burn-off area and a drying furnace upstream from the microzone banks.

6. The thermal processing system of claim 1, further comprising a burn-off area and a drying furnace upstream from the microzone banks and a cooling chamber downstream from the microzone banks.

7. The thermal processing system of claim 1, wherein the microzone banks are spaced apart and the system further comprises a conveyor that transports work pieces along the path of travel and between the microzone banks.

8. The thermal processing system of claim 7, wherein the conveyor is configured to contact work pieces solely along two peripheral edges of the work pieces so as to thermally decouple the conveyor from the work pieces.

9. The thermal processing system of claim 1 further comprising a conveyor configured to transport working pieces through the system along the path of travel, wherein the lamps of the microzones are spaced a distance of less than 2 inches away from the conveyor.

10. The thermal processing system of claim 3, further comprising a conveyor configured to transport working pieces through the system along the path of travel; wherein the burn-off area is comprised of a plurality of paired burn-off zones disposed in opposed position along the path of travel, the burn-off zones have one or more lamps in each burn-off zone, the lamps of the burn-off zone being spaced a distance of about 2 inches to about 4 inches from the conveyor and the lamps of the microzones are spaced a distance of less than 2 inches away from the conveyor.

11. The thermal processing system of claim 1, wherein a temperature sensor is disposed in at least one of each pair of opposed microzones such that it represents the temperature of the heat source.

12. The thermal processing system of claim 1, wherein at least one process parameter sensor is disposed in at least one of each pair of opposed microzones.

13. The thermal processing system of claim 1, further comprising an electronic control system.

14. The thermal processing system of claim 1, further comprising an electronic controller; wherein the controller is configured to dynamically control temperatures or firing profiles in the microzones.

15. The thermal processing system of claim 1, further comprising at least one process parameter sensor disposed in at least one of each pair of opposed microzones and an electronic controller; wherein the controller is in electronic communication with the lamps and at least one processor parameter sensor and the controller is configured to dynamically control temperatures or firing profiles in the microzones.

16. The thermal processing system of claim 1, wherein the lamps are tuned to emit infrared radiation at wavelengths in the range of 1 micron to 2.5 microns.

17. The thermal processing system of claim 1, wherein the microzones have a width based upon the target residence time.

18. The thermal processing system of claim 7, further comprising at least one transmissive shield positioned between the conveyor and the upper microzone bank and/or between the conveyor and the lower microzone bank
